(19) United States
(12) Patent Application Publication
(10) Pub. No.: US 2026/0204064 A1
(43) Pub. Date: Jul. 16, 2026

(54) IMAGE PROCESSING APPARATUS, IMAGE PROCESSING METHOD, AND PROGRAM

(71) Applicant: FUJIFILM Corporation, Tokyo (JP)

(72) Inventor: Shinji HAYASHI, Tokyo (JP)

(73) Assignee: FUJIFILM Corporation, Tokyo (JP)

(21) Appl. No.: 19/561,603

(22) Filed: Mar. 10, 2026

Related U.S. Application Data
(63) Continuation of application No. PCT/JP2024/030215, filed on Aug. 26, 2024.

(30) Foreign Application Priority Data
Sep. 13, 2023 (JP) 2023-148541

(51) Int. Cl. G06V 20/17; G06T 5/50; G06T 7/70

(52) U.S. Cl. CPC G06V 20/17; G06T 5/50; G06T 7/70; G06T 2207/20221; G06T 2207/30244

(57) ABSTRACT

Provided are an image processing apparatus, an image processing method, and a program with which a user such as an imaging person can easily ascertain an imaging status of a set area. An image processing apparatus includes one or more processors, and one or more memories that store a program to be executed by the one or more processors, in which the processor is configured to execute an instruction of the program to: acquire a set area; acquire a group of images in which the set area is captured by using a camera; acquire a map including the set area; calculate meta-information of each image of the group of images; calculate an imaging status of the set area based on the meta-information of each of the images; and output visualization information in which a result of the calculation is superimposed on the set area of the map.

### CROSS-REFERENCE TO RELATED APPLICATIONS

The present application is a Continuation of PCT International Application No. PCT/JP2024/030215 filed on Aug. 26, 2024 claiming priority under 35 U.S.C § 119(a) to Japanese Patent Application No. 2023-148541 filed on Sep. 13, 2023. Each of the above applications is hereby expressly incorporated by reference, in its entirety, into the present application.

### BACKGROUND OF THE INVENTION

### 1. Field of the Invention

The present invention relates to an image processing apparatus, an image processing method, and a program, and particularly relates to a technology of visualizing an imaging status of an area.

2. Description of the Related Art

In a case of a disaster, a local government flies a plurality of drones at the same time to capture an aerial image of a local government area, and ascertains a disaster status of a house from the aerial image.

WO2023-047799A discloses a technology of determining a damage level of a house by aligning a captured image with map data and cutting out a region of each house shown in the captured image by collating the region with the map data.

### SUMMARY OF THE INVENTION

In the aerial image, in a case where there is an uncaptured region in a target area, the disaster status of the region cannot be ascertained. Therefore, it is preferable that the number of uncaptured regions is small. In addition, in a case where a ground resolution of the aerial image is low, it is difficult to ascertain the disaster status of the target area. Therefore, it is preferable that the ground resolution is high. Further, in order to ascertain the disaster status of the house, it is preferable that the aerial image is captured at an appropriate camera angle.

However, it is difficult for a user such as an imaging person to ascertain the imaging status of the aerial image.

The present invention has been made in view of such circumstances, and an object thereof is to provide an image processing apparatus, an image processing method, and a program with which a user such as an imaging person can easily ascertain an imaging status of a set area.

In order to achieve the above object, an image processing apparatus according to a first aspect of the present disclosure is an image processing apparatus comprising: one or more processors; and one or more memories that store a program to be executed by the one or more processors, in which the processor is configured to execute an instruction of the program to: acquire a set area; acquire a group of images in which the set area is captured by using a camera; acquire a map including the set area; calculate meta-information of each image of the group of images; calculate an imaging status of the set area based on the meta-information of each of the images; and output visualization information in which a result of the calculation is superimposed on the set area of the map.

According to the first aspect, the user such as the imaging person can easily ascertain the imaging status of the set area.

According to a second aspect of the present disclosure, in the image processing apparatus according to the first aspect, it is preferable that the processor is configured to: acquire a plurality of set areas; acquire a group of images in which each set area of the plurality of set areas is captured; acquire a map including the plurality of set areas; calculate an imaging status of each of the set areas based on the meta-information of each of the images; and superimpose the result of the calculation on each of the set areas of the map.

According to a third aspect of the present disclosure, in the image processing apparatus according to the first or second aspect, it is preferable that the processor is configured to superimpose at least one of a color, a shade, a hatching, or a contour line corresponding to the result of the calculation on the set area of the map.

According to a fourth aspect of the present disclosure, in the image processing apparatus according to any one of the first to third aspects, it is preferable that the meta-information includes latitude information and longitude information of four corners of each of the images, and the imaging status is the number of the images.

According to a fifth aspect of the present disclosure, in the image processing apparatus according to any one of the first to fourth aspects, it is preferable that the meta-information includes position information and orientation information of the camera during imaging, and the imaging status is an angle distribution of the camera.

According to a sixth aspect of the present disclosure, in the image processing apparatus according to any one of the first to fifth aspects, it is preferable that the map includes information on a house, the meta-information includes position information and orientation information of the camera during imaging, the processor is configured to calculate the imaging status of the set area based on a focal length and a sensor size of the camera, and the imaging status is a distribution of a ground resolution for each house included in the image.

According to a seventh aspect of the present disclosure, in the image processing apparatus according to any one of the first to sixth aspects, it is preferable that the meta-information includes latitude information and longitude information of four corners of each of the images, and the imaging status is an area coverage rate that is a ratio of a captured area to an area of the set area.

According to an eighth aspect of the present disclosure, in the image processing apparatus according to any one of the first to seventh aspects, it is preferable that the map includes information on a house, the meta-information includes latitude information and longitude information of four corners of each of the images, and the imaging status is a house coverage rate that is a ratio of the number of captured houses to the number of houses in the set area.

According to a ninth aspect of the present disclosure, in the image processing apparatus according to any one of the first to eighth aspects, it is preferable that text information of the result of the calculation for the set area of the map is output.

According to a tenth aspect of the present disclosure, in the image processing apparatus according to any one of the first to ninth aspects, it is preferable that the group of images is a group of images captured by the camera mounted on a flying object.

In order to achieve the above object, an image processing method according to an eleventh aspect of the present disclosure is an image processing method executed by one or more processors, the method comprising: via the processor, acquiring a set area; acquiring a group of images in which the set area is captured by using a camera; acquiring a map including the set area; calculating meta-information of each image of the group of images; calculating an imaging status of the set area based on the meta-information of each of the images; and outputting visualization information in which a result of the calculation is superimposed on the set area of the map.

According to the eleventh aspect, the user such as the imaging person can easily ascertain the imaging status of the set area.

In order to achieve the above object, a program according to a twelfth aspect of the present disclosure is a program for causing a computer to execute the image processing method according to the eleventh aspect. The present disclosure also includes a non-transitory computer-readable recording medium, such as a compact disk-read only memory (CD-ROM), on which the program according to the twelfth aspect is recorded.

According to the present invention, the user such as the imaging person can easily ascertain the imaging status of the set area.

### BRIEF DESCRIPTION OF THE DRAWINGS

FIG. 1 is a schematic diagram showing a configuration example of a captured image processing system.

FIG. 2 is a block diagram schematically showing an example of an electrical configuration of a drone on which a camera is mounted.

FIG. 3 is a block diagram showing a hardware configuration example of the image processing apparatus.

FIG. 4 is a block diagram showing a functional configuration example of the image processing apparatus.

FIG. 5 is a flowchart showing each step of an image processing method.

FIG. 6 is a diagram showing an example of a set area.

FIG. 7 is a diagram showing an example of a calculation result of a meta-information calculation unit.

FIG. 8 is a diagram showing an example of visualization information.

FIG. 9 is a diagram showing another example of the visualization information.

FIG. 10 is a diagram showing another example of the visualization information.

FIG. 11 is a diagram showing another example of the visualization information.

FIG. 12 is a diagram showing another example of the visualization information.

### DESCRIPTION OF THE PREFERRED EMBODIMENTS

Hereinafter, preferred embodiments of the present invention will be described in detail with reference to the accompanying drawings. In the present specification, identical reference numerals are denoted by identical components, and duplicate descriptions will be omitted as appropriate.

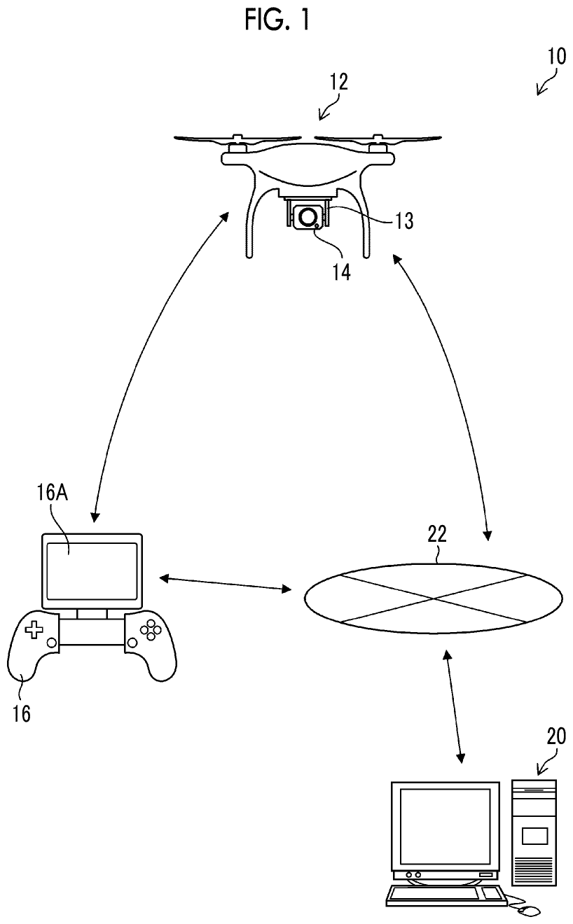

FIG. 1 is a schematic diagram showing a configuration example of a captured image processing system 10. The captured image processing system 10 includes a drone 12 for aerial imaging, a camera 14 mounted on the drone 12, a remote controller 16, and an image processing apparatus 20. The drone 12 is an unmanned aerial vehicle that is remotely operated by an imaging person using the remote controller 16 to perform aerial imaging, and is an example of a flying object. The drone 12 may have an auto-pilot function of flying in accordance with a program.

The camera 14 is mounted on the drone 12 via a gimbal head 13. The camera 14 includes an optical system (not shown), an image sensor, and a signal processing circuit. The optical system includes one or more lenses, such as a focus lens. The image sensor may be, for example, a charge coupled device (CCD) image sensor or a complementary metal-oxide semiconductor (CMOS) image sensor.

The camera 14 generates digital image data of a captured target by processing a signal obtained from the image sensor by the signal processing circuit. The digital image data generated by the camera 14 can be an “image”. The image captured by using the camera 14 is stored in a storage device such as an internal storage built in the drone 12 and/or a memory card that is attachably and detachably mounted on the drone 12. In addition, the image captured by using the camera 14 may be transmitted to the remote controller 16 by using wireless communication, or may be transmitted to the image processing apparatus 20.

The remote controller 16 is a transmitter that controls operations of the camera 14 and the drone 12 via wireless communication. A form of the wireless communication may be a form of a wireless local area network (LAN). The form of the wireless communication may be a communication form using radio waves in a 2.4 GHz band or a 5.7 GHz band. The form of the wireless communication may be a form using a mobile communication network. A communication form of a control signal for controlling the drone 12 and a communication form for transmitting the image captured by using the camera 14 or the like may be different from each other or may be common to each other.

The remote controller 16 comprises a display 16A, left and right sticks (not shown) for operating a flight operation of the drone 12, a lever (not shown) for operating the gimbal head 13, an imaging button (not shown) for instructing the imaging by the camera 14, and an imaging mode button (not shown) for switching between video imaging and still image imaging.

The display 16A may be a touch panel display. Various operations on the drone 12, the gimbal head 13, and the camera 14 may be performed by a touch operation on the touch panel display. The touch operation includes a tap operation, a double tap operation, a flick operation, a swipe operation, a drag operation, a pinch-in operation, and a pinch-out operation.

A live video captured by using the camera 14 is displayed on the display 16A of the remote controller 16 or the like. In addition, the remote controller 16 ascertains a situation of an aircraft, such as a flight position and a flight speed, in real time based on data of various sensors provided in the drone 12. Flight information indicating the situation of the aircraft may be displayed on the display 16A.

The captured image processing system 10 captures a plurality of still images (captured images) from the air by using the camera 14, and processes the captured images in the image processing apparatus 20.

The image processing apparatus 20 is for automatically setting a ground control point (GCP) required for generating a high-accuracy three-dimensional model and an ortho image from a group of aerial images in which images adjacent to each other have an overlap region. The GCP is a point on the ground of which a latitude, a longitude, and an elevation are known, and is a point of a characteristic terrain that is visible on the image. The image processing apparatus 20 may generate a high-accuracy three-dimensional model and an ortho image from the group of aerial images.

The image processing apparatus 20 is configured by a computer. The computer applied to the image processing apparatus 20 may be a server, a personal computer, or a workstation.

The image processing apparatus 20 performs data communication with the remote controller 16 via a network 22. The network 22 may be a local area network or a wide area network. The image processing apparatus 20 acquires various types of information from the drone 12 and the camera 14. The image processing apparatus 20 acquires map data of an imaging target range from a geographical information system (not shown) via the network 22. The image processing apparatus 20 may acquire the map data in advance before the imaging by the camera 14, or may acquire the map data after the imaging by the camera 14.

### Configuration Example of Drone Equipped with Camera

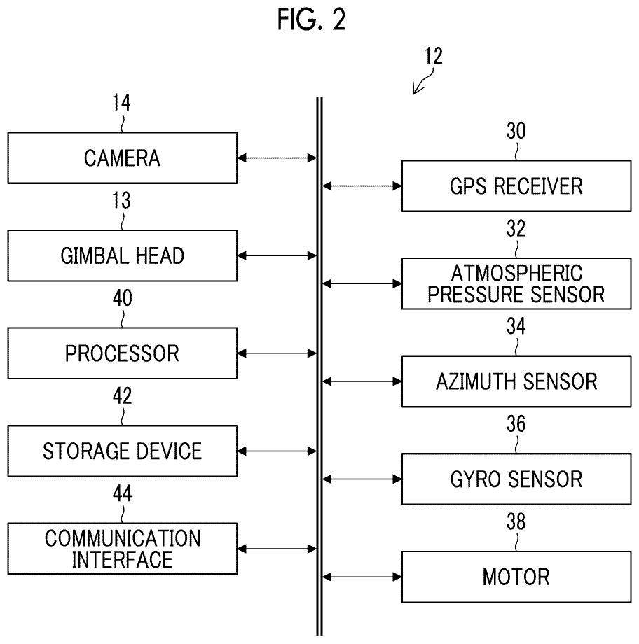

FIG. 2 is a block diagram schematically showing an example of an electrical configuration of the drone 12 on which the camera 14 is mounted. The drone 12 includes a global positioning system (GPS) receiver 30, an atmospheric pressure sensor 32, an azimuth sensor 34, a gyro sensor 36, a motor 38, a processor 40, a storage device 42, a communication interface 44, a battery (not shown), and a charging terminal of the battery.

The GPS receiver 30 acquires a latitude and a longitude of a position of the drone 12. The atmospheric pressure sensor 32 detects an atmospheric pressure of the position of the drone 12. The drone 12 acquires an altitude of the position of the drone 12 based on the atmospheric pressure detected by using the atmospheric pressure sensor 32. The term “acquisition” includes the concept of generating information through data processing, such as calculation. The latitude, the longitude, and the altitude of the drone 12 constitute position information including the latitude information, the longitude information, and the altitude information of the camera 14.

The azimuth sensor 34 may be, for example, a geomagnetic sensor. The drone 12 detects an azimuth angle in which a lens of the camera 14 faces by the azimuth sensor 34.

The gyro sensor 36 detects a roll angle indicating a rotation angle with respect to a roll axis, a pitch angle indicating a rotation angle with respect to a pitch axis, and a yaw angle indicating a rotation angle with respect to a yaw axis. The drone 12 acquires orientation information of the camera 14 based on the rotation angle acquired by using the gyro sensor 36. It should be noted that a part or all of sensors, such as the GPS receiver 30, the atmospheric pressure sensor 32, the azimuth sensor 34, and the gyro sensor 36, may be disposed on the camera 14 side.

The motor 38 is a power source that rotates a rotary wing (rotor) (not shown). The drone 12 includes a plurality of motors 38 that drive a plurality of rotary wings.

The storage device 42 may be a memory, an internal storage, an external storage device, or a combination thereof. The processor 40 acts as a flight controller, and performs various operations necessary for flight control of the drone 12 based on sensor data obtained from various sensors.

The communication interface 44 is a communication unit that performs the wireless communication with the remote controller 16 and the like. The communication interface 44 may comprise a communication terminal corresponding to wired communication.

### Overview of Image Processing Apparatus

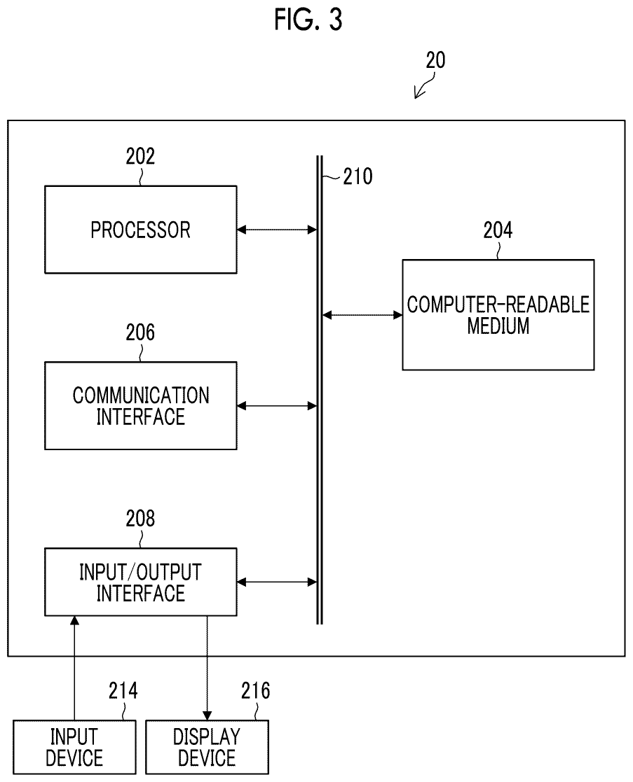

FIG. 3 is a block diagram showing a hardware configuration example of the image processing apparatus 20. The image processing apparatus 20 includes one or more processors 202, one or more computer-readable media 204, a communication interface 206, an input/output interface 208, and a bus 210.

A hardware structure of the processor 202 is various processors as described below. The various types of processors include a central processing unit (CPU) that is a general-purpose processor which acts as various types of functional units by executing software (program), a graphics processing unit (GPU) that is a processor specialized in image processing, a programmable logic device (PLD) that is a processor of which a circuit configuration is changeable after manufacture, such as a field programmable gate array (FPGA), and a dedicated electric circuit that is a processor which has a circuit configuration specifically designed in order to execute specific processing, such as an application specific integrated circuit (ASIC).

One processing unit may be configured by one of the various types of processors or may be configured by the same type or different types of two or more processors (for example, a plurality of FPGAs, a combination of a CPU and an FPGA, or a combination of a CPU and a GPU). In addition, one processor may configure a plurality of functional units. As an example of configuring a plurality of functional units by one processor, first, there is a form in which one processor is configured by a combination of one or more CPUs and software and the processor acts as the plurality of functional units, as represented by a computer such as a client and a server. Second, there is a form in which a processor that realizes functions of the entire system including a plurality of functional units with one integrated circuit (IC) chip is used, as represented by a system on chip (SoC) or the like. As described above, the various types of functional units are configured by one or more of the various types of processors used as a hardware structure.

Further, the hardware structure of the various types of processors is, more specifically, an electric circuit (circuitry) in which circuit elements such as semiconductor elements are combined.

The processor 202 is connected to the computer-readable medium 204, the communication interface 206, and the input/output interface 208 through the bus 210.

The computer-readable medium 204 stores an instruction to be executed by the processor 202. The computer-readable medium 204 includes a memory that is a main memory, and a storage that is an auxiliary memory. For example, the computer-readable medium 204 may be a semiconductor memory, a hard disk drive (HDD) device, a solid state drive (SSD) device, or a combination thereof. The computer-readable medium 204 stores various programs, data, and the like including an image processing program.

The communication interface 206 controls communication via the network 22.

The input/output interface 208 is connected to an input device 214 and a display device 216, and controls input and output to the image processing apparatus 20.

The input device 214 is configured by, for example, a keyboard, a mouse, a multi-touch panel, another pointing device, a voice input device, or an appropriate combination thereof.

The display device 216 is configured, for example, by using a liquid crystal display, an organic electro-luminescence (OEL) display, a projector, or an appropriate combination thereof.

The image processing apparatus 20 may have a configuration including the input device 214 and the display device 216.

### Functional Configuration of Image Processing Apparatus

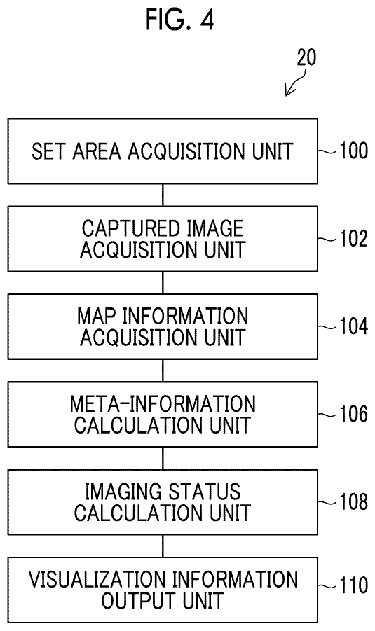

FIG. 4 is a block diagram showing a functional configuration example of the image processing apparatus 20. The image processing apparatus 20 includes a set area acquisition unit 100, a captured image acquisition unit 102, a map information acquisition unit 104, a meta-information calculation unit 106, an imaging status calculation unit 108, and a visualization information output unit 110. Each function of the image processing apparatus 20 is materialized by the processor 202 executing the program stored in the computer-readable medium 204.

The set area acquisition unit 100 acquires a set area for visualizing the imaging status. For example, the user divides an aerial imaging region that is a certain imaging region into a plurality of regions for which the respective imaging status is to be visualized. It is preferable that the plurality of regions are divided such that there is no gap between the regions adjacent to each other and there is no overlap between the regions adjacent to each other. Each of the plurality of regions may be a different administrative division. The set area acquisition unit 100 acquires each of the divided plurality of regions as a plurality of set areas.

The captured image acquisition unit 102 acquires a plurality of images (an example of a “group of images”) in which the aerial imaging region is captured by using the camera 14 from the camera 14. The captured image acquisition unit 102 acquires a plurality of images in which a part of the aerial imaging region is respectively captured, and the plurality of images are captured with an overlap region with images adjacent to each other.

The map information acquisition unit 104 acquires map information including an imaging region of the plurality of images acquired by the captured image acquisition unit 102, that is, map information including the aerial imaging region. The map information acquisition unit 104 may acquire the map information from the computer-readable medium 204, may acquire the map information from the input device 214, or may acquire the map information via the network 22.

The meta-information calculation unit 106 calculates the meta-information of each image of the plurality of images acquired by the captured image acquisition unit 102. The meta-information of each image includes, for example, latitude and longitude information including the latitude and the longitude of four corners of the imaging region of each image, and a ground resolution of a house included in each image.

The meta-information calculation unit 106 may acquire sensor data and camera information recorded as an exchange image file format (exif) data from each image. The sensor data includes the latitude, the longitude, the altitude, the roll angle, the pitch angle, and the yaw angle of the camera 14 at the time of imaging. The camera information includes a sensor size and a focal length of the camera 14.

The meta-information calculation unit 106 may match the sensor data and the camera information of each image with the map information acquired by the map information acquisition unit 104 to obtain accurate position information and accurate orientation information of the camera 14 at the time of imaging. The meta-information calculation unit 106 may apply a georeferencing technique to the captured image and project a road line segment of the map to the captured image with an accuracy of about within an error of 3 to 5 meters.

The meta-information calculation unit 106 may acquire house information from the map information acquired by the map information acquisition unit 104.

The imaging status calculation unit 108 calculates the imaging status of the set area based on the meta-information of each image calculated by the meta-information calculation unit 106. The imaging status of the set area includes the number of sheets of captured images, the camera angle distribution, the ground resolution distribution, the imaging coverage rate, and the imaging overlap rate.

The number of sheets of captured images is the number of images in which the set area is captured. The number of sheets of captured images may be a total number of images in which the set area is captured, or may be the number of images per unit area. The unit area may be 1 square kilometer.

The camera angle is an angle of a downward inclination of an optical axis of the lens of the camera 14 with respect to a horizontal direction. The camera angle is obtained from the orientation information of the camera 14 or the pitch angle of the sensor data. The camera angle distribution is a distribution of an appearance frequency of the camera angle for each image. The camera angle distribution is represented by, for example, a histogram showing the number of images belonging to each of intervals of a predetermined constant interval of the value of the camera angle. In addition, the camera angle distribution may be the number of images in which the nadir is captured and the number of images in which the oblique is captured, or may be a ratio of these.

The ground resolution is a size of a house included in the image, that is, a house captured in the image in a real space per one pixel of the image. The ground resolution is obtained from the sensor size of the camera 14, an actual distance of four corners of the imaging range, and information on a position of the house obtained from the map information. The ground resolution distribution is a distribution of an appearance frequency of the ground resolution for each house. The ground resolution distribution is represented by, for example, a histogram showing the number of houses belonging to each of intervals of a predetermined constant interval of the value of the ground resolution.

The imaging coverage rate includes an area coverage rate and a house coverage rate. The area coverage rate is a ratio of an area of a region captured in the set area to an area of the set area. The area of the set area is obtained from the map information of the set area. In addition, the area of the captured region is obtained from the latitude and longitude information of the four corners of each image. The house coverage rate is a ratio of the number of captured houses to the number of houses in the set area. The number of houses in the set area is obtained from the house information of the map information. In addition, the number of captured houses is obtained from the house information of the map information and the latitude and longitude information of the four corners of each image.

The imaging overlap rate is a ratio of an overlap region that is captured to overlap with an image other than the image to the imaging region shown in the image. The imaging overlap rate is obtained from an average of ratios of an area of the imaging region of each image to an area of the overlap region of the image.

The visualization information output unit 110 generates and outputs the visualization information in which the result of the calculated imaging status is superimposed on the set area of the map. The visualization information output unit 110 may generate and output the visualization information in which the result of the calculated imaging status is superimposed on the set area of the map according to a predetermined legend. The predetermined legend may fill the set area with at least one of a color, a shade, or a hatching corresponding to the result of the calculated imaging status. The filling includes making the filled area transparent in order to recognize information on the map such as a road and a house even after the filling. The predetermined legend may superimpose a contour line corresponding to the result of the calculated imaging status. The contour line may outline the set area with at least one of a color, a shade, or a line type corresponding to the result of the calculated imaging status.

The visualization information output from the visualization information output unit 110 is displayed on, for example, the display device 216. The visualization information may be stored in the computer-readable medium 204, or may be transmitted to a device connected to the network 22 via the communication interface 206.

The user such as the imaging person can easily ascertain the imaging status of the set area by the visualization information output from the visualization information output unit 110.

### Image Processing Method

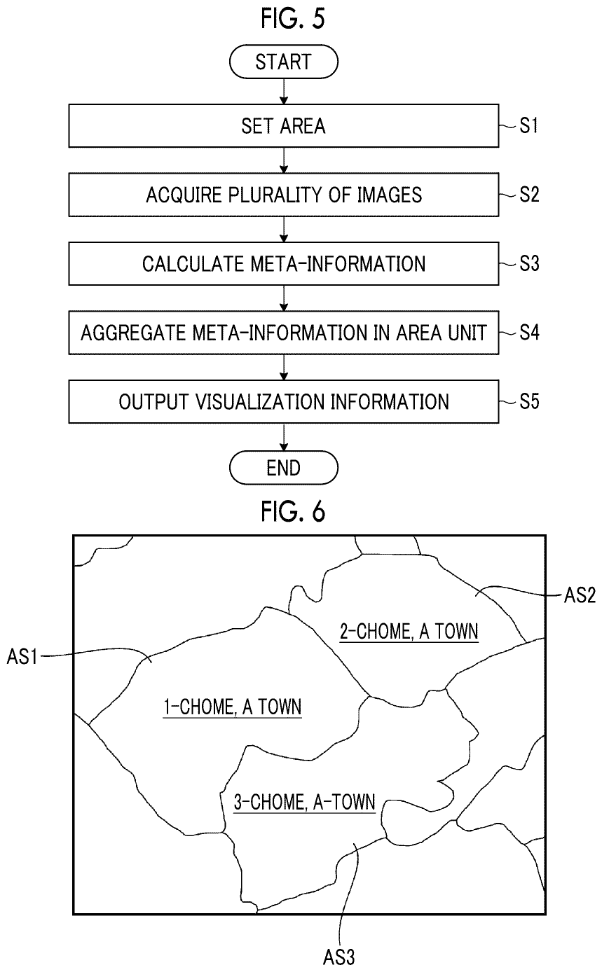

FIG. 5 is a flowchart showing each step of the image processing method. The image processing method enables the user such as the imaging person to easily ascertain the imaging status of the set area for a plurality of aerial images captured by using the drone 12. The image processing method is implemented by the processor 202 executing an image processing program stored in the computer-readable medium 204. The image processing program may be provided by a non-transitory computer-readable storage medium, or may be provided via the network 22.

In step S1, the user sets an area for ascertaining the imaging status. The image processing apparatus 20 acquires the area set by the user as the set area.

For example, the user of the local government that performs aerial imaging may divide the local government area that is the aerial imaging region into a plurality of areas in units of districts, towns, villages, blocks, or the like. In a case where the user divides the local government area into a plurality of areas, the set area acquisition unit 100 acquires the plurality of areas as each set area. The user may set the area by inputting a selection instruction to the map displayed on the display device 216 by using the input device 214.

FIG. 6 is a diagram showing an example of the set area. Here, an example is shown in which the user divides the local government area into a plurality of areas of “1-chome, A Town”, “2-chome, A Town”, and “3-chome, A Town”. As shown in FIG. 6, “1-chome, A Town” is set as a set area AS1, “2-chome, A Town” is set as a set area AS2, and “3-chome, A Town” is set as a set area AS3.

In step S2, the image processing apparatus 20 acquires the plurality of images.

Here, the captured image acquisition unit 102 acquires a plurality of still images in which the local government area is captured with overlap in one flight of the drone 12, and a part of the local government area is respectively captured.

In step S3, the image processing apparatus 20 calculates the meta-information of each image of the plurality of images acquired in step S2.

Here, the map information acquisition unit 104 acquires map information including the local government area that is the aerial imaging region. The meta-information calculation unit 106 acquires house information from the map information acquired by the map information acquisition unit 104.

In addition, the meta-information calculation unit 106 acquires the exif data from each image of the plurality of images acquired in step S2. Further, the meta-information calculation unit 106 acquires the sensor data and the camera information from the exif data.

Next, the meta-information calculation unit 106 matches the sensor data and the camera information of each image with the map information to obtain the accurate position information and the accurate orientation information of the camera 14 at the time of imaging. Subsequently, the meta-information calculation unit 106 calculates the latitude and longitude information of four corners of the imaging region of each image based on the obtained position information and orientation information of the camera 14. Further, the meta-information calculation unit 106 calculates the ground resolution of each house in the image based on the house information and the position information and the orientation information of the camera 14.

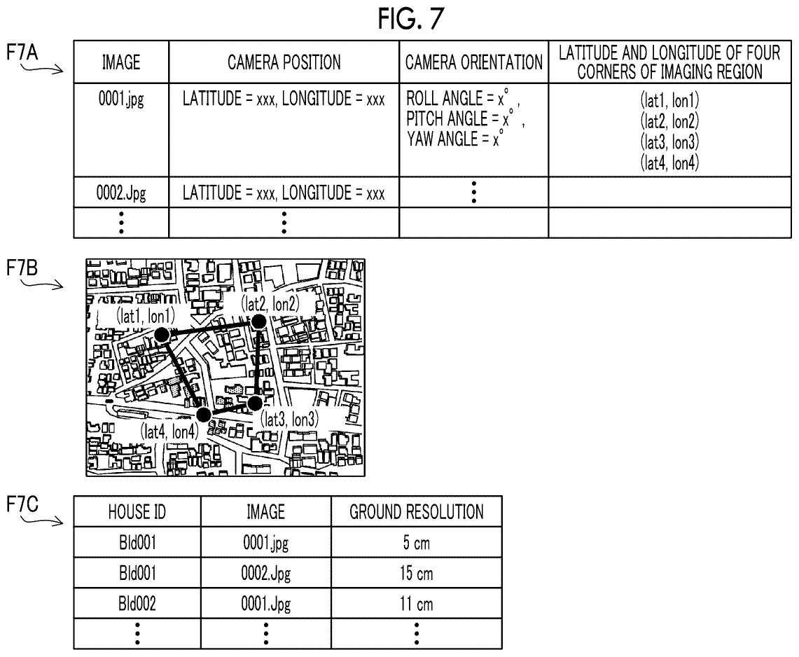

FIG. 7 is a diagram showing an example of a calculation result of the meta-information calculation unit 106. F7A shown in FIG. 7 is a table showing the position information of the camera at the time of imaging, the orientation information of the camera, and the latitude and longitude information of four corners of the imaging region for each image. In F7A, for each of images “0001.jpg”, “0002.jpg”, and the like, the latitude and longitude information as the camera position information and the roll angle, the pitch angle, and the yaw angle are calculated as the camera orientation information.

F7B shown in FIG. 7 is a diagram showing an image of four corners of the imaging region of the image “0001.jpg”. In F7B, (lat1, lon1), (lat2, lon2), (lat3, lon3), and (lat4, lon4), which are the latitude and longitude information of four corners of the imaging region of the image “0001.jpg”, are plotted at corresponding positions on the map, and the imaging region is indicated by surrounding the plotted points with a straight line.

F7C shown in FIG. 7 is a table showing the ground resolution for each house for each image. Here, the image in which each house of house IDs “Bld001”, “Bld002”, . . . is shown and the ground resolution are associated with each other. For example, it is shown that the house of the house ID “Bld001” is shown with a ground resolution of “5 cm” in the image “0001.jpg” and is shown with a ground resolution of “15 cm” in the image “0002.jpg”.

Returning to the description of FIG. 5, in step S4, the image processing apparatus 20 aggregates the meta-information calculated in step S3 in units of the set area acquired in step S1.

Here, the imaging status calculation unit 108 calculates the number of sheets of captured images, the camera angle distribution, the ground resolution distribution, and the imaging coverage rate for each set area of the plurality of set areas acquired in step S1, respectively.

Finally, in step S5, the image processing apparatus 20 generates the visualization information in which the meta-information aggregated in step S4 in units of the set area is superimposed on a region of the set area on the map, and outputs the visualization information to the display device 216. The display device 216 displays the visualization information acquired from the image processing apparatus 20.

The user such as the imaging person can easily ascertain the imaging status of the set area by the visualization information output in step S5.

### Display of Visualization Information

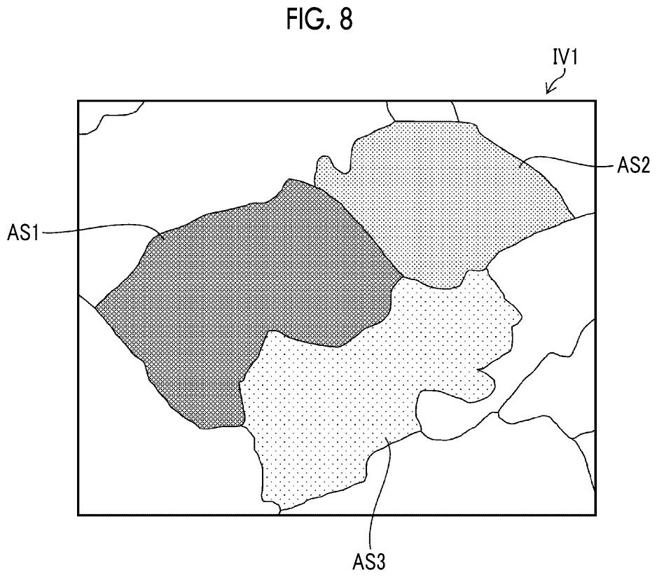

FIG. 8 is a diagram showing an example of the visualization information displayed on the display device 216 in step S5. In visualization information IV1 shown in FIG. 8, each of the set area AS1, the set area AS2, and the set area AS3 is hatched with hatching corresponding to the meta-information, and the hatching of the predetermined legend is superimposed on the region of each set area on the map. The meta-information includes at least one of the number of sheets of captured images, the camera angle distribution, the ground resolution distribution, the imaging coverage rate, or the imaging overlap rate.

The user can ascertain a difference in the imaging status for each set area by the visualization information IV1.

In a case where the user performs a selection operation on any of the set area AS1, the set area AS2, or the set area AS3 by using the input device 214 in a state in which the visualization information IV1 shown in FIG. 8 is displayed on the display device 216, the imaging status of the selected set area is displayed in a pop-up manner. The selection operation is, for example, a click operation after moving a mouse cursor to a desired set area.

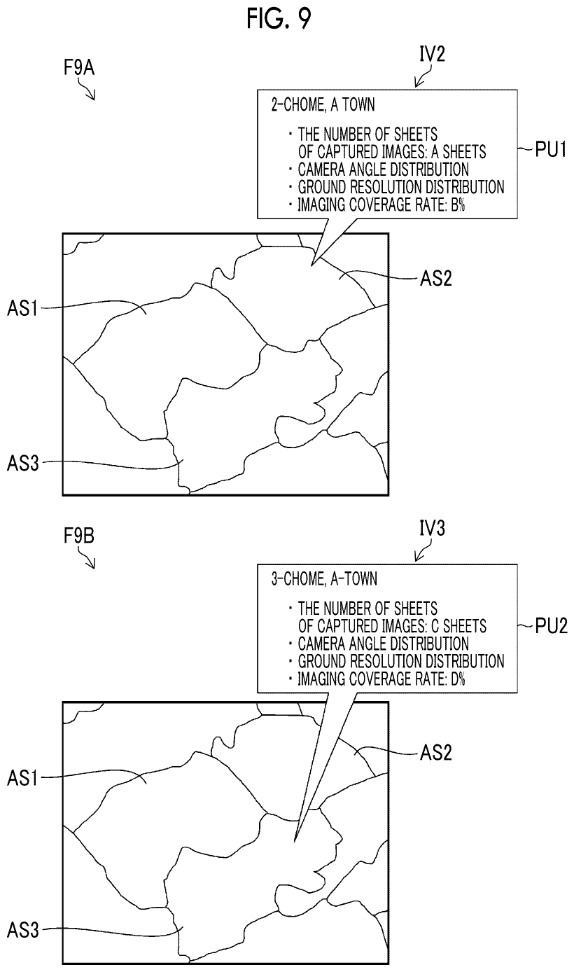

FIG. 9 is a diagram showing an example of the visualization information displayed on the display device 216 after the selection operation of the set area. F9A shown in FIG. 9 shows the visualization information IV2 in a case where the set area AS2 of the visualization information IV1 is subjected to the selection operation. In the visualization information IV2, a pop-up display PU1 is displayed as the text information for the set area AS2. The pop-up display PU1 has a balloon shape and includes a rectangular portion for indicating information on the set area and a sharp portion for indicating which set area it is. The pop-up display PU1 includes an “area name”, the “number of sheets of captured images”, the “camera angle distribution”, the “ground resolution distribution”, and the “imaging coverage rate”. Here, the “area name” is “2-chome, A Town”, the “number of sheets of captured images” is “A sheets”, and the “imaging coverage rate” is “B %”.

Here, the example has been described in which the visualization information IV2 is displayed in a pop-up manner on the visualization information IV1, but the display screen of the visualization information IV2 may be transitioned and displayed from the display screen of the visualization information IV1.

F9B shown in FIG. 9 shows the visualization information IV3 in a case where the set area AS3 of the visualization information IV1 is subjected to the selection operation. In the visualization information IV3, a pop-up display PU2 is displayed as the text information for the set area AS3. The pop-up display PU2 includes an “area name”, the “number of sheets of captured images”, the “camera angle distribution”, the “ground resolution distribution”, and the “imaging coverage rate”. Here, the “area name” is “3-chome, A Town ”, the “number of sheets of captured images” is “C sheets”, and the “imaging coverage rate” is “D %”.

In the visualization information IV2 and the visualization information IV3, the values are not displayed for the “camera angle distribution” and the “ground resolution distribution”, but may be displayed. For example, for the “camera angle distribution”, the “number of images in which the nadir is captured” and the “number of images in which the oblique is captured” may be displayed. In addition, for the “ground resolution distribution”, an “average value of the ground resolution of all houses” may be displayed.

The user can ascertain the imaging status of the set area of which the details are desired to be known by the visualization information IV2 and the visualization information IV3.

In a case where the user performs a selection operation on any of the items of “camera angle distribution” or “ground resolution distribution” by using the input device 214 in a state in which the visualization information IV2 or the visualization information IV3 shown in FIG. 9 is displayed on the display device 216, the display device 216 transitions to the display of the visualization information of the selected item. The visualization information of the selected item is, for example, a graph display of the selected item.

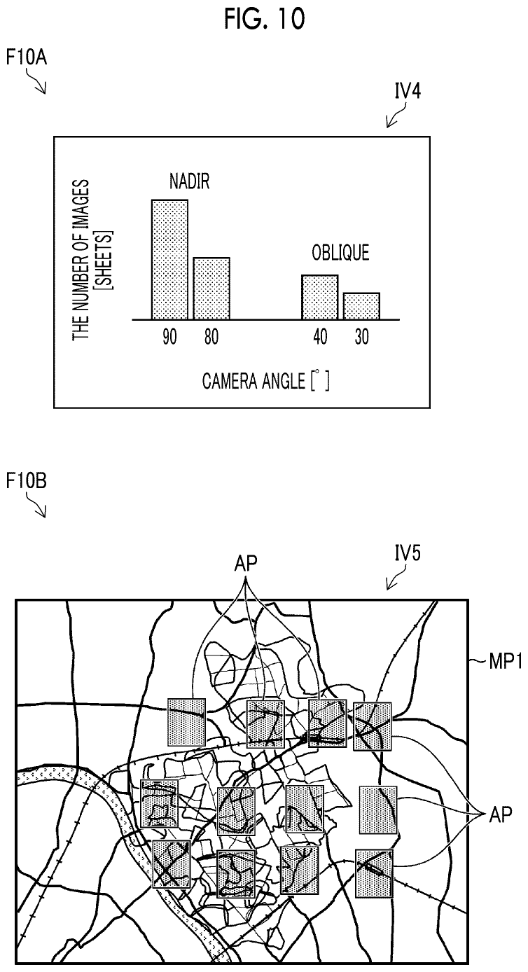

FIG. 10 is a diagram showing an example of the visualization information displayed on the display device 216 after the selection operation of the item. F10A shown in FIG. 10 shows the visualization information IV4 in a case where the “camera angle distribution” of the pop-up display PU1 is subjected to the selection operation. The visualization information IV4 includes a histogram showing a distribution of the camera angles of the images in which the set area AS2 is captured. In the histogram, the horizontal axis indicates “camera angle (unit: degree)”, and the vertical axis indicates “number of images (unit: sheets)”. Here, the image in which the camera angle at the time of imaging is 25 to 34 degrees is classified as “30 degrees”, and the image in which the camera angle at the time of imaging is 35 to 44 degrees is classified as “40 degrees”. Similarly, the image in which the camera angle at the time of imaging is 75 to 84 degrees is classified as “80 degrees”, and the image in which the camera angle at the time of imaging is 85 to 94 degrees is classified as “90 degrees”. In addition, here, the “camera angle” is classified as “90 degrees” and “80 degrees” as “nadir”, and “40 degrees” and “30 degrees” as “oblique”.

The user can ascertain the camera angle distribution of the set area of which the details are desired to be known by the visualization information IV4.

In a case where the user performs a selection operation on any of the camera angles of the “camera angle” of the histogram by using the input device 214 in a state in which the visualization information IV4 shown in F10A is displayed on the display device 216, the visualization information of the selected camera angle is displayed. The visualization information of the selected camera angle is, for example, a region captured at the selected camera angle.

F10B shown in FIG. 10 shows the visualization information IV5 in a case where “40 degrees” of the camera angles of the visualization information IV4 is subjected to the selection operation. The visualization information IV5 includes a map MP1 of the set area AS2, and 12 regions AP each captured by 12 images in which the camera angle at the time of imaging is 35 to 44 degrees are superimposed on the map MP1.

The user can ascertain the region captured at the selected camera angle in the set area by the visualization information IV5.

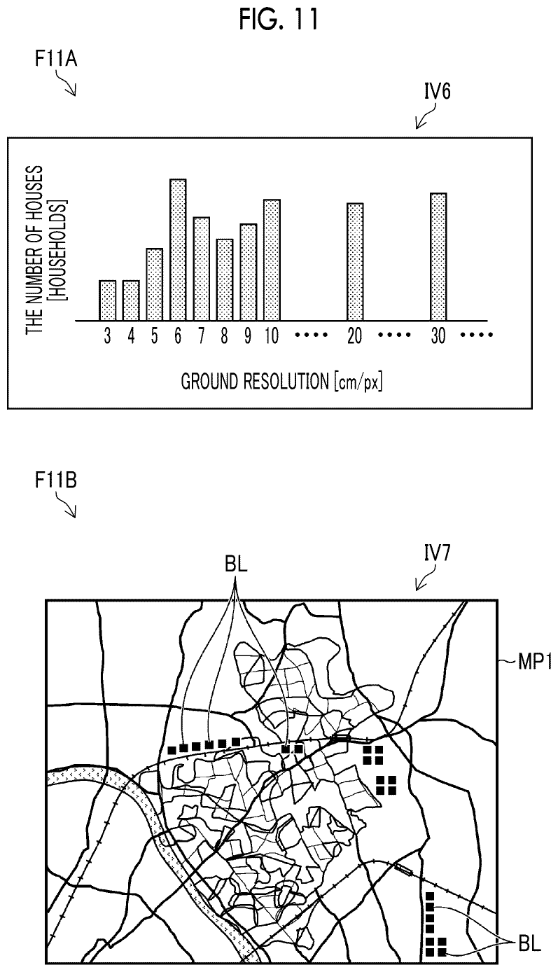

FIG. 11 is a diagram showing another example of the visualization information displayed on the display device 216 after the selection operation of the item. F11A shown in FIG. 11 shows the visualization information IV6 in a case where the “ground resolution distribution” of the pop-up display PU1 is subjected to the selection operation. The visualization information IV6 includes a histogram showing a distribution of the ground resolution of the house shown in the image in which the set area AS2 is captured. In the histogram, the horizontal axis indicates “ground resolution (unit: centimeter/pixel)”, and the vertical axis indicates the “number of houses (unit: houses)”. Here, each house is classified into a ground resolution of 4 to 30 centimeters/pixel in increments of 1 centimeter/pixel. For example, the house having a ground resolution of 2.5 to 3.4 centimeters/pixel is classified as “3 centimeters/pixel”.

The user can ascertain the ground resolution distribution of the set area of which the details are desired to be known by the visualization information IV6.

In a case where the user performs a selection operation on any of the ground resolutions of the “ground resolution” of the histogram by using the input device 214 in a state in which the visualization information IV6 shown in F11A is displayed on the display device 216, the visualization information of the selected ground resolution is displayed. The visualization information of the ground resolution is, for example, a position of the house captured at the selected ground resolution.

F11B shown in FIG. 11 shows the visualization information IV7 in a case where “3 centimeters/pixel” of the “ground resolution” of the visualization information IV6 is subjected to the selection operation. The visualization information IV7 includes a map MP1 of the set area AS2, and a position of a house BL having a ground resolution of 3 centimeters/pixel is superimposed on the map MP1.

The user can ascertain the house captured at the selected ground resolution in the house of the set area by the visualization information IV7.

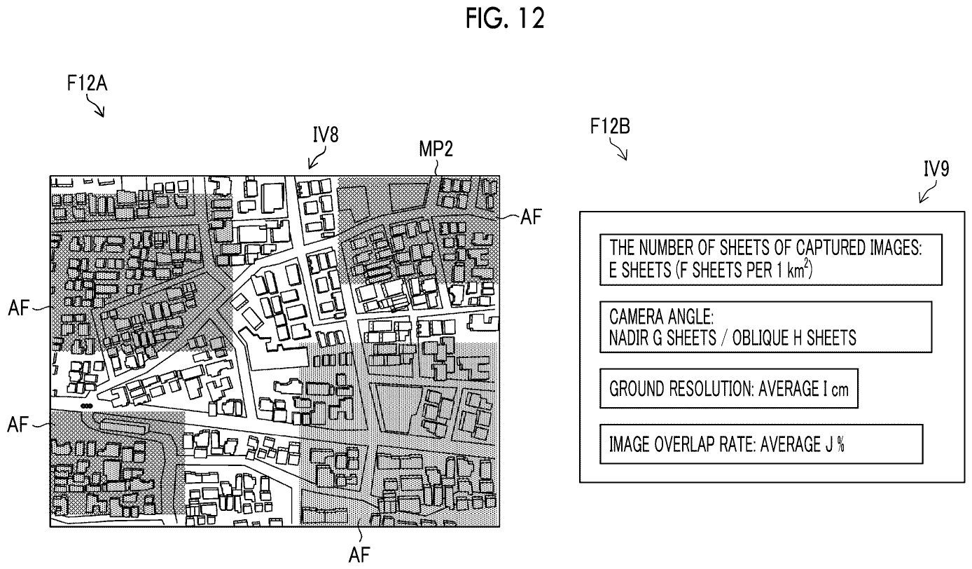

FIG. 12 is a diagram showing another example of the visualization information displayed on the display device 216. F12A shown in FIG. 12 shows the visualization information IV8. The visualization information IV8 includes a map MP2 including the aerial imaging region, and a region AF captured on the map MP2 is superimposed. The region AF is a region captured by the plurality of images. The region AF is calculated from the latitude and longitude information of four corners of the imaging region of each image. The number of sheets of images in which each region AF is captured may be superimposed on the region AF.

The user can ascertain a range of the captured region by the visualization information IV8.

In a case where the user performs a selection operation on any of the regions AF by using the input device 214 in a state in which the visualization information IV8 shown in F12A is displayed on the display device 216, the display device 216 transitions to the display of the imaging status of the selected region AF.

F12B shown in FIG. 12 shows the visualization information IV9 in a case where any of the regions AF of the visualization information IV8 is subjected to the selection operation. The visualization information IV9 is the imaging status for the selected region AF. The visualization information IV9 includes the “number of sheets of captured images”, the “camera angle”, the “ground resolution”, and the “imaging overlap rate”. Here, the “number of sheets of captured images” is “E sheets (F sheets per square kilometer)”, the “camera angle” is “nadir G sheets/oblique H sheets”, the “ground resolution” is “average I centimeters”, and the “imaging overlap rate” is J %.

In a case where the user performs a selection operation on any of the items of “the number of sheets of captured images”, “camera angle”, “ground resolution”, and “imaging overlap rate” by using the input device 214 in a state in which the visualization information IV9 shown in F12B is displayed on the display device 216, the display device 216 may transition to the display of the visualization information of the selected item. The visualization information of the selected item is, for example, a graph display of the selected item.

### Others

The technical scope of the present invention is not limited to the scope described in the above-described embodiments. The configuration and the like in each embodiment can be combined between the embodiments as appropriate without departing from the gist of the present invention.

### EXPLANATION OF REFERENCES

10: captured image processing system
12: drone
13: gimbal head
14: camera
16: remote controller
16A: display
20: image processing apparatus
22: network
30: GPS receiver
32: atmospheric pressure sensor
34: azimuth sensor
36: gyro sensor
38: motor
40: processor
42: storage device
44: communication interface
100: set area acquisition unit
102: captured image acquisition unit
104: map information acquisition unit
106: meta-information calculation unit
108: imaging status calculation unit
110: visualization information output unit
202: processor
204: computer-readable medium
206: communication interface
208: input/output interface
210: bus
214: input device
216: display device
AF: region
AP: region
AS1: set area
AS2: set area
AS3: set area
BL: house
ID: house
IV1: visualization information
IV2: visualization information
IV3: visualization information
IV4: visualization information
IV5: visualization information
IV6: visualization information
IV7: visualization information
IV8: visualization information
IV9: visualization information
MP1: map
MP2: map
PU1: pop-up display
PU2: pop-up display
S1 to S5: steps of image processing method

What is claimed is:

1. An image processing apparatus comprising:
one or more processors; and
one or more memories that store a program to be executed by the one or more processors,
wherein the processor is configured to execute an instruction of the program to:
acquire a set area;
acquire a group of images in which the set area is captured by using a camera;
acquire a map including the set area;
calculate meta-information of each image of the group of images;
calculate an imaging status of the set area based on the meta-information of each of the images; and
output visualization information in which a result of the calculation is superimposed on the set area of the map.

2. The image processing apparatus according to claim 1,
wherein the processor is configured to:
acquire a plurality of set areas;
acquire a group of images in which each set area of the plurality of set areas is captured;
acquire a map including the plurality of set areas;
calculate an imaging status of each of the set areas based on the meta-information of each of the images; and
superimpose the result of the calculation on each of the set areas of the map.

3. The image processing apparatus according to claim 1,
wherein the processor is configured to superimpose at least one of a color, a shade, a hatching, or a contour line corresponding to the result of the calculation on the set area of the map.

4. The image processing apparatus according to claim 1,
wherein the meta-information includes latitude information and longitude information of four corners of each of the images, and
the imaging status is the number of the images.

5. The image processing apparatus according to claim 1,
wherein the meta-information includes position information and orientation information of the camera during imaging, and
the imaging status is an angle distribution of the camera.

6. The image processing apparatus according to claim 1,
wherein the map includes information on a house,
the meta-information includes position information and orientation information of the camera during imaging,
the processor is configured to calculate the imaging status of the set area based on a focal length and a sensor size of the camera, and
the imaging status is a distribution of a ground resolution for each house included in the image.

7. The image processing apparatus according to claim 1,
wherein the meta-information includes latitude information and longitude information of four corners of each of the images, and
the imaging status is an area coverage rate that is a ratio of a captured area to an area of the set area.

8. The image processing apparatus according to claim 1,
wherein the map includes information on a house,
the meta-information includes latitude information and longitude information of four corners of each of the images, and
the imaging status is a house coverage rate that is a ratio of the number of captured houses to the number of houses in the set area.

9. The image processing apparatus according to claim 1,
wherein text information of the result of the calculation for the set area of the map is output.

10. The image processing apparatus according to claim 1,
wherein the group of images is a group of images captured by the camera mounted on a flying object.

11. An image processing method executed by one or more processors, the method comprising:
via the processor,
acquiring a set area;
acquiring a group of images in which the set area is captured by using a camera;
acquiring a map including the set area;
calculating meta-information of each image of the group of images;
calculating an imaging status of the set area based on the meta-information of each of the images; and
outputting visualization information in which a result of the calculation is superimposed on the set area of the map.

12. A non-transitory, computer-readable tangible recording medium on which a program for causing, when read by a computer, the computer to execute the image processing method according to claim 11 is recorded.
